(19) United States
(12) Patent Application Publication
(10) Pub. No.: US 2013/0326278 A1
(43) Pub. Date: Dec. 5, 2013

(54) SERVER AND METHOD OF MANIPULATION IN RELATION TO SERVER SERIAL PORTS

(71) Applicants: Hong Fu Jin Precision Industry (ShenZhen) Co., Ltd., (US); HON HAI PRECISION INDUSTRY CO., LTD., New Taipei (TW)

(72) Inventors: JI-ZHI YIN, Shenzhen (CN); CUN-HUI FAN, Shenzhen (CN)

(73) Assignees: Hon Hai Precision Industry Co., Ltd., New Taipei (TW); Hong Fu Jin Precision Industry (ShenZhen) Co., Ltd, Shenzhen (CN)

(21) Appl. No.: 13/875,320

(22) Filed: May 2, 2013

(30) Foreign Application Priority Data
May 30, 2012 (CN) 201210172796X

(51) Int. Cl. G06F 11/36

(52) U.S. Cl. CPC G06F 11/362
USPC 714/38.1

(57) ABSTRACT

A server in communication with a remote control device and a display device includes a super input/output (SIO) microchip, a basic input/output system (BIOS), and a baseboard management controller (BMC). The SIO microchip outputs debugging commands and IPMI commands. The BMC includes a setting module, receiving module, and a transmitting module. The setting module sets the BIOS to establish communication between the BMC and the SIO microchip. The receiving module receives the IPMI commands or the debugging commands to debug errors of firmware pre-stored in the BMC. The transmitting module outputs the errors of the firmware to the remote control device or the display device via the SIO microchip.

### BACKGROUND

1. Technical Field

The disclosure generally relates to servers, and particularly to a manipulating method for serial ports of a server.

2. Description of the Related Art

Electronic devices, such as servers, often employ a baseboard management controller (BMC). To activate the BMC, firmware is written in the BMC. Since no communication is established between a system serial port of the server and a debugging port of the BMC, thus, if the firmware is in an error state, operators cannot obtain the error state via the system serial port. It may be inconvenient for operators to have to open a chassis of the server, and use cables and debugging cards to plug into the debugging port for analysis purposes.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments.

FIG. 1 is a block diagram illustrating a server, according to an exemplary embodiment.

FIG. 2 is a block diagram illustrating a baseboard management controller (BMC) of the server as shown in FIG. 1.

FIG. 3 is a flowchart illustrating a manipulating method for the server as shown in FIG. 1, according to an exemplary embodiment.

### DETAILED DESCRIPTION

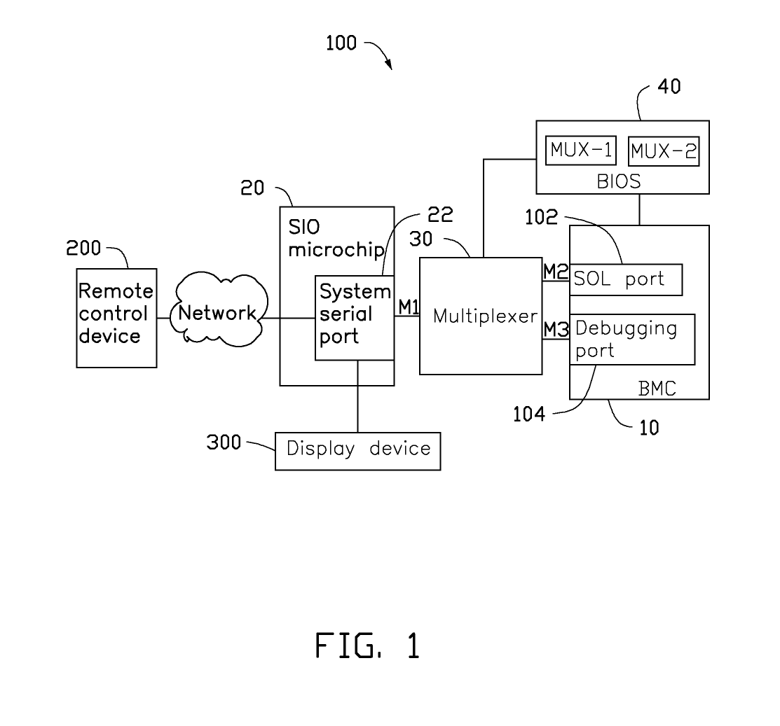

FIG. 1 is a block diagram illustrating a server 100, according to an exemplary embodiment. The server 100 includes a baseboard management controller (BMC) 10, a super input/output (SIO) microchip 20, a multiplexer 30, and a basic input/output system (BIOS) 40.

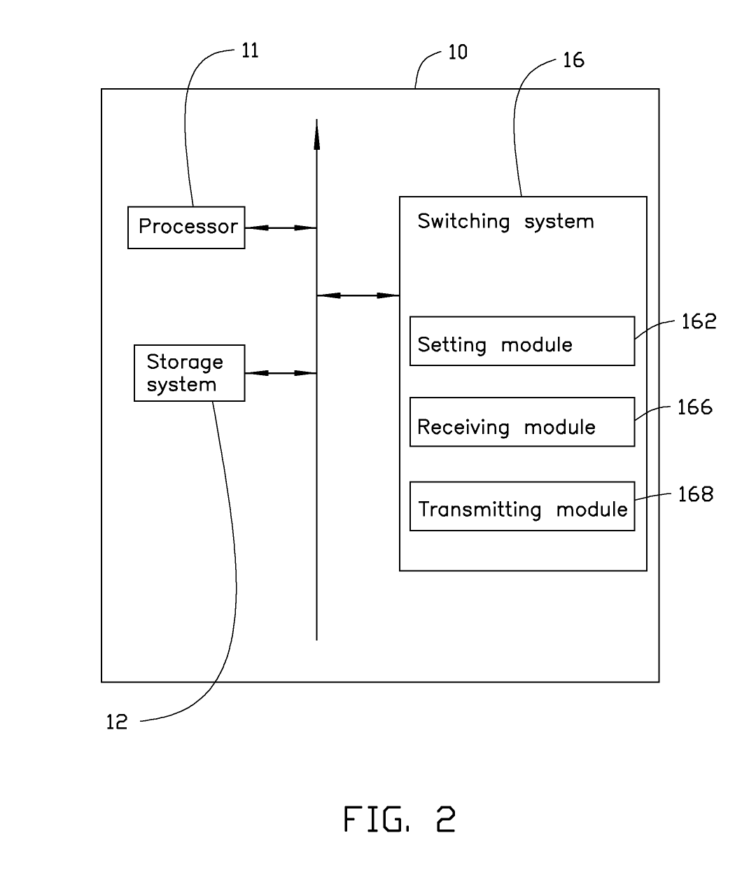

Also referring to FIG. 2, the BMC 10 includes a processor 11, a storage system 12, a serial over local area network (SOL) port 102, and a debugging port 104. In one embodiment, the storage system 12 may be an internal storage system of the BMC 10, such as a random access memory (RAM) for temporary storage of information, and/or a read only memory (ROM) for permanent storage of information. In some embodiments, the storage system 12 may also be an external storage system, such as an external hard disk drive, a storage card, or a data storage medium. To activate the BMC 10, firmware is pre-written in the storage system 12. If the firmware is in an error state, the BMC 10 records and stores errors of the firmware.

The SIO microchip 20 includes a system serial port 22. In one embodiment, the system serial port 22 is a virtual universal asynchronous receiver/transmitter (UART). The system serial port 22 is configured to be electronically connected to a remote control device 200 (e.g., a cloud computer) via a network. The system serial port 22 transmits intelligent platform management interface (IPMI) commands from the remote control device 200 to the SOL port 102 of the BMC 10 to debug the errors of the firmware, and receive the errors of the firmware from the SOL port 102. The errors of the firmware can be displayed on the remote control device 200.

Additionally, the SIO microchip 20 pre-stores debugging commands, and the system serial port 22 is further configured to be electronically connected to a display device 300. The system serial port 22 transmits the debugging commands from the SIO microchip 20 to the debugging port 104 of the BMC 10 to debug the errors of the firmware, and receive the errors of the firmware from the debugging port 104. The errors of the firmware can be displayed on the display device 300.

The multiplexer 30 includes a first terminal M1, a second terminal M2, and a third terminal M3. The first terminal M1 is electronically connected to the system serial port 22, and is selectably and electronically connected to the second terminal M2 or to the third terminal M3. The second terminal M2 is electronically connected to the SOL port 102, and the third terminal M3 is electronically connected to the debugging port 104.

The BIOS 40 controls the multiplexer 30 to allow the SIO microchip 20 to establish communication with the SOL port 102 or the debugging port 104. Specifically, the BIOS 40 defines a first menu MUX-1 and a second menu MUX-2. If the first menu MUX-1 is selected, the BIOS 40 controls the first terminal M1 to be electronically connected to the second terminal M2, thus communication between the system serial port 22 and the SOL port 102 is established. If the second menu MUX-2 is selected, the BIOS 40 controls the first terminal M1 to be electronically connected to the third terminal M3, thus communication between the SIO microchip 20 and the debugging port 104 is established. In one embodiment, the first menu MUX-1 is selected by default.

The BMC 10 further includes a switching system 16. The switching system 16 includes a setting module 162, a receiving module 166, and a transmitting module 168. The setting module 162, the receiving module 166, and the transmitting module 168 may include a plurality of programs in the form of one or more computerized instructions stored in the storage system 12 and executed by the processor 11 to perform operations of the BMC 10. In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules, and may be stored in any type of non-transitory computer-readable medium or other storage device. Some non-limiting examples of non-transitory computer-readable mediums include compact discs (CDs), digital versatile discs (DVDs), flash memory, and hard disk drives (HDD).

The setting module 162 sets the BIOS 30 to select the first menu MUX-1 or the second menu MUX-2.

The receiving module 166 receives intelligent platform management interface (IPMI) commands from the SOL port 102 or the debugging port 104, to allow the remote control device 200 or the SIO microchip 20 to access the BMC 10, and then to debug the errors of the firmware.

The transmitting module 168 outputs the errors of the firmware to the system serial port 22 via the SOL port 102 or the debugging port 104, to allow the errors of the firmware to be shown on the remote control device 200 or on the display device 300.

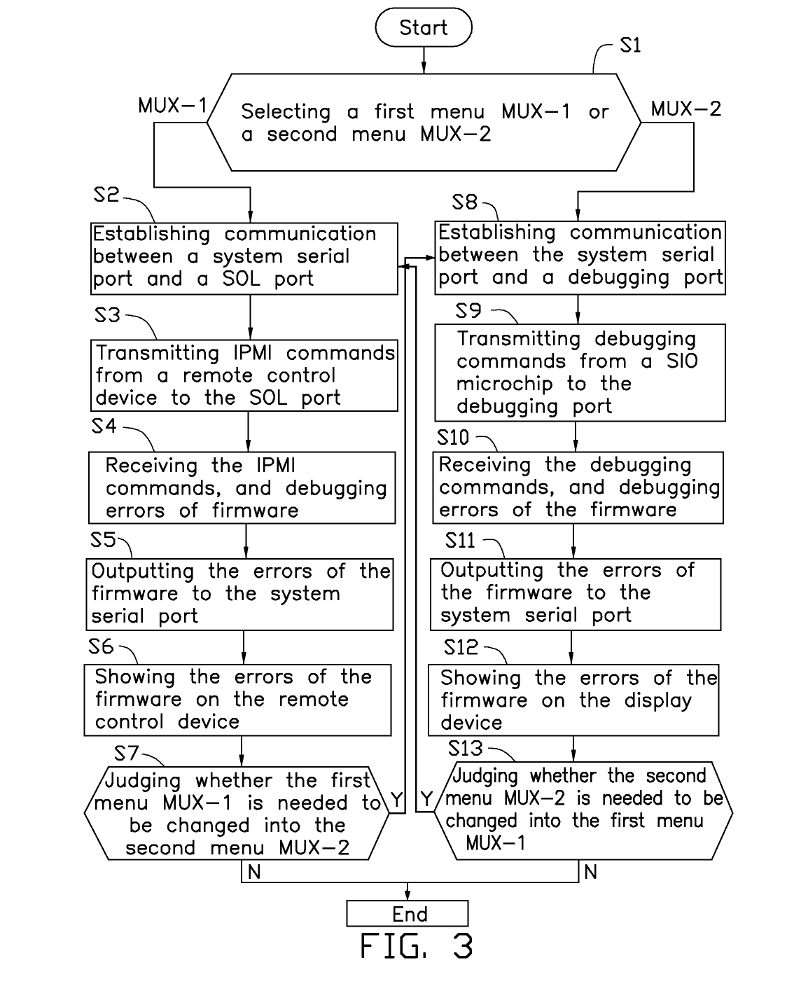

Also referring to FIG. 3, a manipulating method for the server 100 is described according to an exemplary embodiment. The manipulating method includes at least following steps:

In step S1, the setting module 162 sets the BIOS 30. If the first menu MUX-1 is selected, step S2 is implemented. If the second menu MUX-2 is selected, step S8 is implemented.

In step S2, the BIOS 40 controls the first terminal M1 to be electronically connected to the second terminal M2, to establish communication between the system serial port 22 and the SOL port 102.

In step S3, the system serial port 22 transmits the IPMI commands from the remote control device 200 to the SOL port 102.

In step S4, the receiving module 166 receives IPMI commands, and then the remote control device 200 accesses the BMC 10 and debugs the errors of the firmware.

In step S5, the transmitting module 168 outputs the errors of the firmware to the system serial port 22 via the SOL port 102.

In step S6, the remote control device 200 shows the errors of the firmware.

In step S7, a determination is made whether the first menu MUX-1 needs to be changed into the second menu MUX-2. If the first menu MUX-1 is changed into the second menu MUX-2, step S8 is implemented.

In step S8, the BIOS 40 controls the first terminal M1 to be electronically connected to the third terminal M3, to establish communication between the system serial port 22 and the debugging port 104.

In step S9, the system serial port 22 transmits the debugging commands from the SIO microchip 20 to the debugging port 104.

In step S10, the receiving module 166 receives debugging commands, and then the SIO microchip 20 accesses the BMC 10 and debugs the errors of the firmware.

In step S11, the transmitting module 168 outputs the errors of the firmware to the system serial port 22 via the SOL port 102.

In step S12, the display device 300 shows the errors of the firmware.

In step S13, a determination is made whether the second menu MUX-2 needs to be changed into the first menu MUX-1. If the second menu MUX-2 is changed into the first menu MUX-1, step S2 is implemented

In summary, the switching system 16 sets the BIOS 30 to further control the SIO microchip 20 to be electronically connected to the SOL port 102 or to the debugging port 104. Thus, both the remote control device 200 communicating with the server 100 via a network and the display device 300 connected to the server 100 can display the errors of the firmware stored in the BMC 10. Since the BMC 10 can be simultaneously monitored by the remote control device 200 and the display device 300, the chassis of the server does not need to be opened, and cables and debugging cards are also not needed. This is very convenient for operators to maintain the server 100.

Although numerous characteristics and advantages of the exemplary embodiments have been set forth in the foregoing description, together with details of the structures and functions of the exemplary embodiments, the disclosure is illustrative only, and changes may be made in detail, especially in the matters of arrangement of parts within the principles of disclosure to the full extent indicated by the broad general meaning of the terms in which the appended claims are expressed.

What is claimed is:

1. A server in communication with a remote control device and a display device, the server comprising:
a super input/output (SIO) microchip outputting debugging commands, and receiving IPMI commands from the remote control device;
a basic input/output system (BIOS) defining a first menu and a second menu;
a multiplexer controlled by the BIOS; and
a baseboard management controller (BMC), comprising:
a processor;
a storage system storing firmware; and
one or more programs stored in the storage system and executed by the processor, the one or more programs comprising:
a setting module selecting the first menu or the second menu; wherein if the first menu is selected, the SIO microchip outputs the IPMI commands to the BMC via the multiplexer; if the second menu is selected, the SIO microchip outputs the debugging commands to the BMC via the multiplexer;
a receiving module receiving the IPMI commands or the debugging commands to debug errors of the firmware; and
a transmitting module outputting the errors of the firmware to the remote control device or the display device via the SIO microchip.

2. The server as claimed in claim 1, wherein the SIO microchip includes a system serial port, and the BMC further includes a serial over local area network (SOL) port and a debugging port; the multiplexer includes a first terminal, a second terminal, and a third terminal, the first terminal is electronically connected to the system serial port, and is selectably and electronically connected to the second terminal or the third terminal, the second terminal is electronically connected to the SOL port, and the third terminal is electronically connected to the debugging port.

3. The server as claimed in claim 2, wherein if the first menu is selected, the first terminal is electronically connected to the second terminal; and if the second menu is selected, the first terminal is electronically connected to the third terminal.

4. The server as claimed in claim 1, wherein the errors of the firmware are shown on the remote control device or the display device.

5. The server as claimed in claim 1, wherein the system serial port is a virtual universal asynchronous receiver/transmitter (UART), the system serial port is electronically connected to the remote control device via a network, and is wired connected to the display device.

6. A server in communication with a remote control device and a display device, the server comprising:
a super input/output (SIO) microchip outputting debugging commands, and receiving IPMI commands from the remote control device;
a basic input/output system (BIOS);
a multiplexer controlled by the BIOS; and
a baseboard management controller (BMC), comprising:
a processor;
a storage system storing firmware; and
a switching system comprising one or more programs stored in the storage system and executed by the processor to:
set the BIOS to establish communication between the SIO microchip and the BMC via the multiplexer to allow the SIO microchip to output the debugging commands or the IPMI commands to the BMC;
receive the IPMI commands or the debugging commands to debug errors of the firmware;
output the errors of the firmware to the remote control device or the display device via the SIO microchip.

7. The server as claimed in claim 6, wherein the BIOS defines a first menu and a second menu, the one or more programs are further executed by the processor to select the first menu or the second menu.

8. The server as claimed in claim 7, wherein if the first menu is selected, the SIO microchip outputs the IPMI commands to the BMC; if the second menu is selected, the SIO microchip outputs the debugging commands to the BMC.

9. The server as claimed in claim 8, wherein the SIO microchip includes a system serial port, and the BMC further includes a serial over local area network (SOL) port and a debugging port; the multiplexer includes a first terminal, a second terminal, and a third terminal, the first terminal is electronically connected to the system serial port, and is selectably and electronically connected to the second terminal or the third terminal, the second terminal is electronically connected to the SOL port, and the third terminal is electronically connected to the debugging port.

10. The server as claimed in claim 9, wherein if the first menu is selected, the first terminal is electronically connected to the second terminal; and if the second menu is selected, the first terminal is electronically connected to the third terminal.

11. A manipulating method for a server, the server in communication with a remote control device and a display device, the manipulating method comprising:
selecting a first menu or a second menu of a basic input/output system (BIOS);
receiving IPMI commands from the remote control device to debug errors of firmware pre-stored in a baseboard management controller (BMC) of the server if the first menu is selected, or receiving debugging commands from the server to debug the errors of the firmware pre-stored in the BMC if the second menu is selected;
outputting the errors of the firmware to the remote control device or the display device.

12. The manipulating method as claimed in claim 11, wherein the step of selecting a first menu or a second menu of a BIOS further comprises:
establishing communication between the BMC and the remote control device via a multiplexer if the first menu is selected; and
establishing communication between the BMC and the display device via the multiplexer if the second menu is selected.

13. The manipulating method as claimed in claim 12, further comprising showing the errors of firmware on the remote control device or on the display device.
